(19) United States
(12) Patent Application Publication
(10) Pub. No.: US 2010/0011540 A1
(43) Pub. Date: Jan. 21, 2010

(54) Pliable handle

(76) Inventor: Shiow-Hui Chen, Hsin-Chu (TW)

Correspondence Address: Shiow-Hui Chen, P.O.Box 166-13, Taipei, 115, TW

(21) Appl. No.: 12/219,167

(22) Filed: Jul. 17, 2008

(51) Int. Cl. B25G 1/10

(52) U.S. Cl. 16/430

(57) ABSTRACT

A pliable handle is defomable as it being held. When the force is released, the pliable handle will retain a deformed shape temporarily and return to an original shape gradually. The pliable handle comprises a middle rod, a lower rod below the middle rod; the lower rod having a buckling seat and an upper position plate; an upper positioning trench being formed between the buckling seat and the upper positioning plate; a plastic cover enclosing around the lower rod; the plastic cover encloses the thin bag containing gel so as to form a space between the lower rod and the thin bag, which is allowed to be wrapped around with several circles; and a base combined to the lower rod and tightly engaging a lower edge of the plastic cover.

### CROSS REFERENCE OF RELATED APPLICATION

The applicant has applied in the USPTO entitled “pliable handle” assigned application Ser. No. 11/054,135 on Feb. 10, 2005 allowed on Jun. 5, 2008.

### FIELD OF THE INVENTION

The present invention relates to handles, and in particular to a pliable handle has a shape conformed to the palm.

### BACKGROUND OF THE INVENTION

There are some prior arts related to pliable handles, such as US 2004/0205937 “Pliable handle” disclosed at Apr. 17, 2004 assigned to Shedrain corporation and US 2004/0205938, “Pliable handle” disclosed at Aug. 23, 2003, also assigned to Shedrain corporation.

The handle of above mentioned prior arts has the effect of temporarily storing a deformed shape as the pressure thereon is released. The pliable handle has a core and a cover enclosing the core. A cavity is formed between the core and the cover. Gel is filled into an inner room of the core through minor holes. Then the gel flows into the cavity from a plurality of lateral holes of the cover. Then the holes are sealed so that the gel is sealed therein. When an external force is applied on the soft handle, the handle will deform. When the external force is released, the handle will not restore immediately. It will retain the shape temporarily until gel flows. Thereby the pliable handle has a memory effect.

However the prior art has the following disadvantages.

Firstly, the flowability of the gel is low and thus the gel easily drains out from the small holes. When the pliable handle is held, the gel will flow due to the pressure from the hand so that the gel flows out from the gaps between the core and the cover. Even a top cover and a lower cover serves to combine the core with the cover, the gel still flows out. Thereby as the pliable handle is used for a longer time, the top cover and the lower cover will loose so that the upper and lower protrusions can not be tightly engaged to the cover.

Secondly, in the manufacturing process, the filling gel process is performed after an initial assembly and then a final assembly is performed. For example, initially, the cover is combined to the core. Then gel is filled and then the top cover and lower cover are engaged. The assembly time is long and the cost is high.

Thirdly, some other parts are used to prevent the gel from flowing out. For example it is illustrated that there are twenty seven numerals specified in FIG. 20 of US 2004/0205938, each represent a labor cost or material cost added to the products. However this will induce the high cost in molding and time consumption. Furthermore, fine machining is necessary for matching all parts.

Fourthly, the drain-preventing and pressure tests are performed after assembly. Thereby the defected products cannot be found in the manufacturing process. They are found after they are produced. This makes the increase of cost.

The cover is a soft plastic cover. When it is used for a long time, it will be destroyed by external forces to generate cracks. As a result, the gel drains out. Thereby the tolerance and safety are not preferred. Thereby the drained gel is possible to be eaten so as to hurt people.

### SUMMARY OF THE INVENTION

Accordingly, the primary object of the present invention provides a soft handle, wherein the parts, such as a lower rod, a bag, a plastic cover, and a base are made independently. Then they are assembled rapidly. In assembly, it is necessary to fill glue so that the assembly work can be performed sequentially. Furthermore, efficiency is high and cost is low.

Furthermore, each part is made independently and thus the part can be updated independently, but the gel will not drain out. Moreover the bag is sealed tightly and the gel is completely sealed in the bag. The problem of draining gel can be resolved. Furthermore, the defected products can be discovered in advance in manufacturing process. The cost is reduced and the assembly process can be shortened.

Furthermore, other than a beautiful outlook, the plastic cover is used as a protecting layer to prevent gel from draining out as the bag is damaged or cracked. Thereby even the cover is bitten the gel do not drain out.

To achieve objectives, the present invention provides a pliable handle which is deformed as it being held. When the force is released, the pliable handle will retain a deformed shape temporarily and return to an original shape gradually. The pliable handle comprises a middle rod, a lower rod below the middle rod; the lower rod having a buckling seat and an upper position plate; an upper positioning trench being formed between the buckling seat and the upper positioning plate; a thin bag wrapped around in several circles is enclosed by a plastic cover; the plastic cover further enclosing around the lower rod so as to form a space between the lower rod and the thin bag; and a base combined with the lower rod and tightly engaging a lower edge of the plastic cover.

Moreover, a light emitting device is installed within the base. The light emitting device includes a light emitting body, at least one battery, and a power control switch; the light of the light emitting body emits toward an upper side.

The various objects and advantages of the present invention will be more readily understood from the following detailed description when read in conjunction with the appended drawing.

### BRIEF DESCRIPTION OF THE DRAWINGS

FIG. 1 is an exploded perspective view of the pliable handle of the present invention.

FIG. 2 is an assembled perspective view of the pliable handle of the present invention.

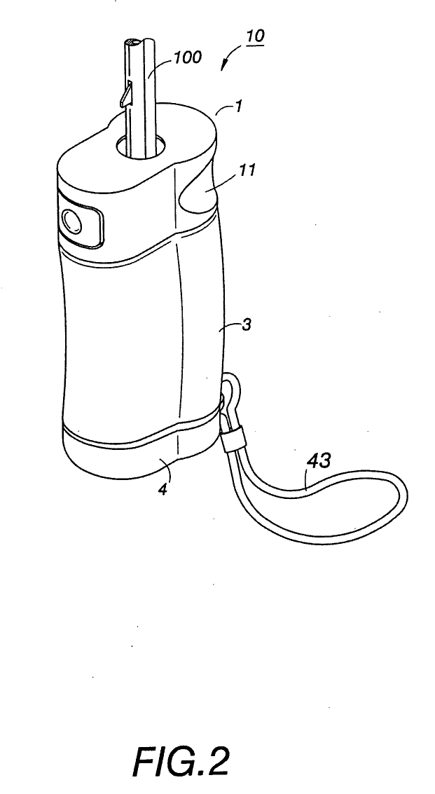

FIG. 3 is a whole cross sectional view about the pliable handle of the present invention.

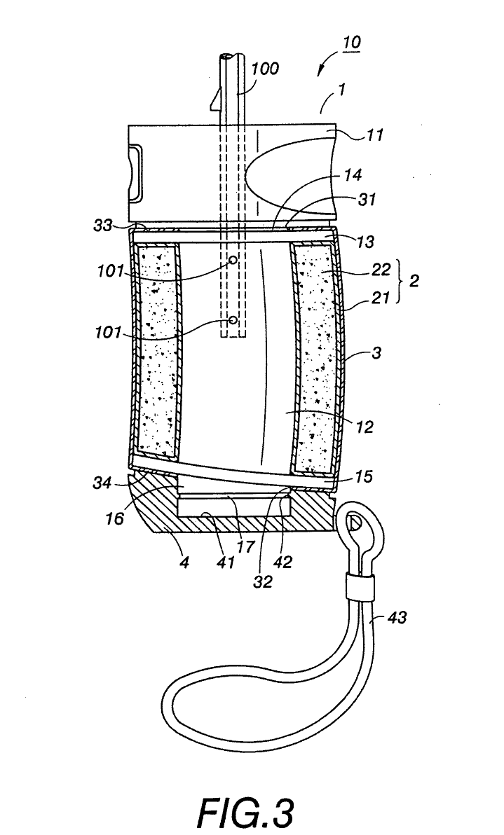

FIG. 4 is a cross sectional view along line IV-IV of FIG. 1.

FIG. 5 shows the use of the pliable handle of the present invention.

FIG. 6 shows the state of a damaged rubber bag of the present invention.

FIG. 7 shows the use of the light emitting device of the pliable handle of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

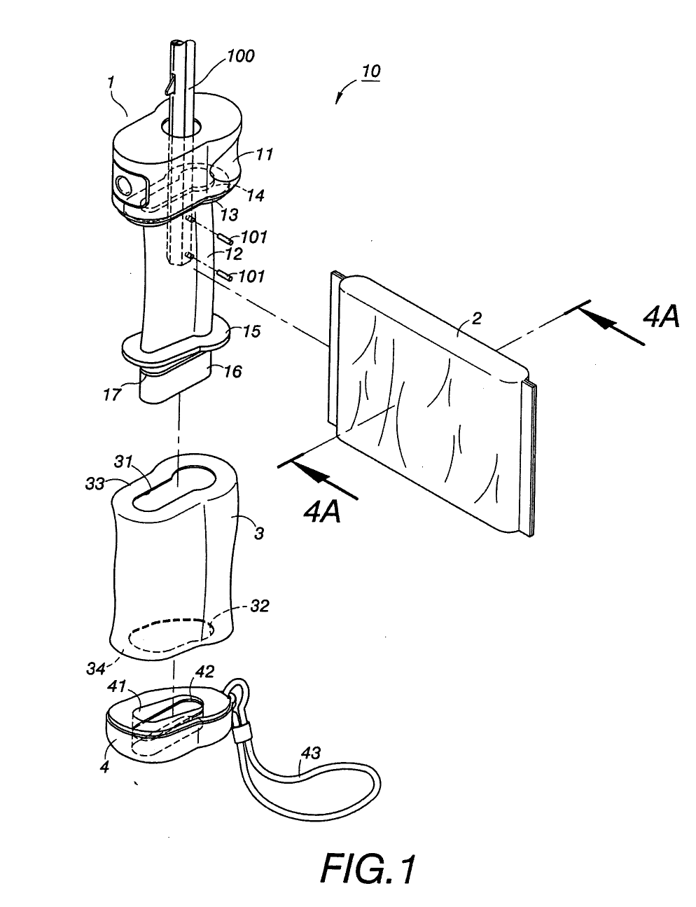

With reference to FIG. 1, the pliable handle 10 of the present invention has the following elements.

A middle rod 100 is one of a rod of an umbrella, a mountaineering rod, a hammer rod, a handle tool, etc.

A lower rod 1 is combined to the middle rod 100 by embedding a stud 101 as shown in FIG. 1, or riveting, or integrally forming. An upper end of the lower rod 1 has a buckling seat 11 for positioning a positioning core 12. A lower end of the buckling seat 11 is installed with a positioning plate 13. An upper positioning trench 14 is formed between the upper positioning plate 13 and the buckling seat 11. A lower end of the positioning core 12 is installed with a lower positioning plate. 15. A bottom portion 16 is protruded downward from the lower positioning plate 15. An annular flange 17 is projected inward from an inner periphery of the bottom portion 16.

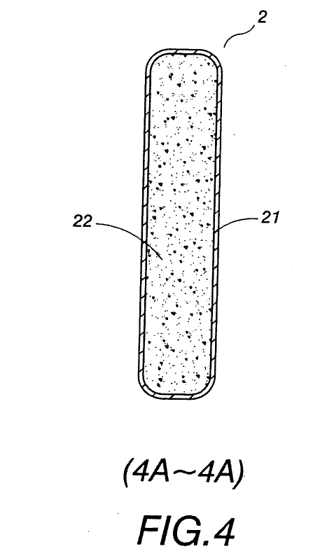

A thin bag 2 (referring to FIG. 4) is formed by filling gel 11 into a thin rubber bag 21 and then sealing an opening of the rubber bag 21 by pressing under high temperature, with high frequency, or through thermal melting adhesive, etc., to acquire the advantages of preferred sealing at low cost. The gel is formed by silicon, or the same mixing with ointment. The thin bag 2 is flattened to be like a sheet. In assembly, the thin bag 2 is wound around an outer surface of the positioning core 12 and is confined between the upper positioning plate 13 and the lower positioning plate 15 steadily. Further, the thin bag 2 can be wound over several circles around the positioning core 12. One circle assembly is preferable in assembly and multiple circles assembly is preferable under the consideration of steadiness.

A plastic cover 3 is a soft structure, extendable, restorable to be deformed. Two ends of the top and lower ends thereof have upper edge 33 and lower edge 34. An upper opening 31 is formed through the upper edge 33 and a lower opening 32 is formed through the lower edge 34. In assembly, the positioning core 12 passes through the openings 31 and 32 so that the top edge is guided into the positioning trench 14 to enclose the upper positioning plate 13. Meanwhile, the upper edge is clamped between the buckle seat 11 and the upper positioning plate 13. The lower edge 34 encloses the lower positioning plate 15 so that the bottom portion 16 protrudes downward out of the lower opening 32. Thereby the plastic cover 3 tightly encloses the thin bag 2.

A base 4 is fixed below the positioning core 12, as the base 4 that is fixed to the bottom portion 16. There are several ways for fixing. For example, the base 4 is installed with a buckling slot 41. In assembly, the bottom portion 16 is guided into the buckling slot 41. A buckle 42 is coupled to the annular flange 17. The base 4 and the lower position plate 15 tightly clamp the lower edge 34 of the plastic cover 3. Besides the lateral sides or bottom end of the base 4 can be threaded with a loop 43 for hanging the umbrella or the like on a hook.

In assembly of the present invention, the bag 2 wound around a periphery of the positioning core 12. Then the plastic cover 3 encloses around the periphery of the thin bag 2 around the positioning core 12. The top edge 33 is embedded into the upper positioning trench 14. The lower edge 34 encloses the lower position plate 15. Finally, the base 4 is fixed to and combined to the bottom portion 16. The lower edge 34 encloses the lower position plate 15. Finally, the base 4 is fixed to and combined to the bottom portion 16. The lower edge 34 is clamped. Neither the amounts of the components required for assembling the pliable handle of the present invention is larger than the prior art. Nor process of filling gel or injection gel is requested. Thereby the assembly work can be performed rapidly. The problem of contamination draining gel can be alleviated. Furthermore, the defected products can be soon discovered in manufacturing process. The cost is reduced and the assembly process can be shortened.

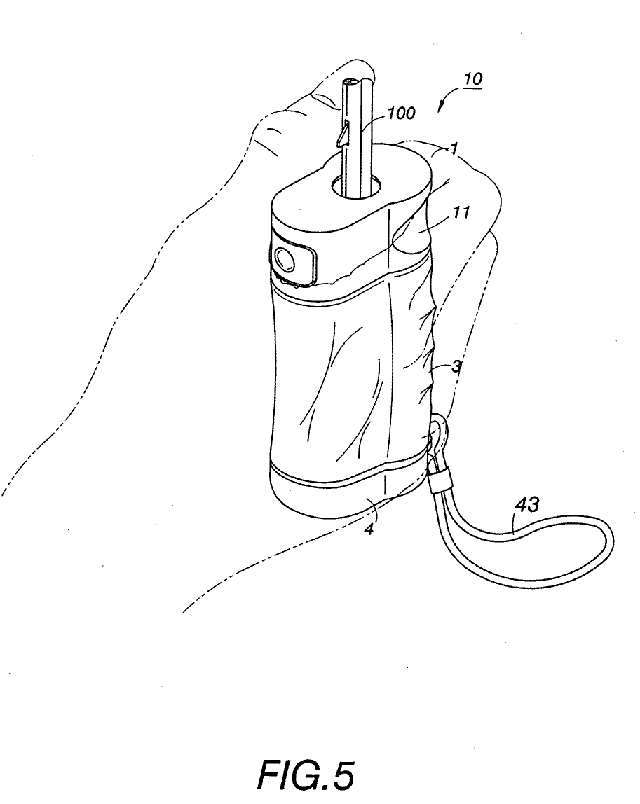

FIG. 5 shows the use of the present invention. When the users hold a pliable handle 10, the plastic cover 3 and the thin bag 2 are deformed due to the pressure from the hand so that the surface of the plastic cover 3 is shaped conformed to the palm, even after the pressure is released, the thin bag 2 will not restore immediately, while it retains the shape temporarily until the gel flows.

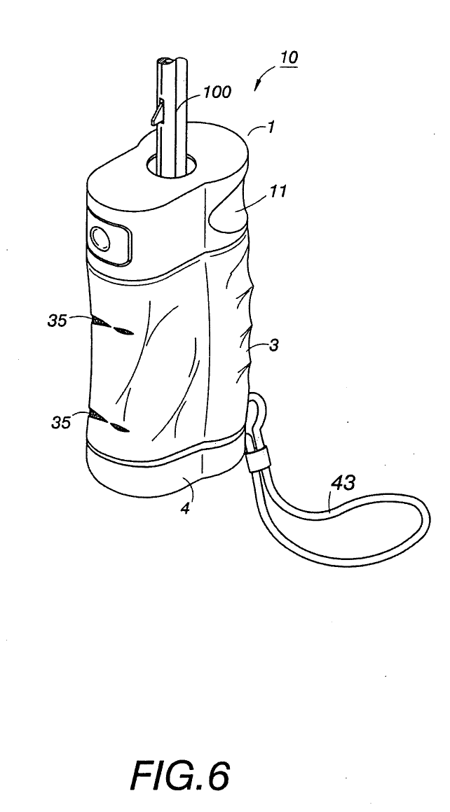

With reference to FIG. 6, the deformation of the thin bag 2 has the effect of delayed or prolonged performance of the thin bag 2. Even the plastic cover 3 generates cracks 35 due to external forces. The internal gel 22 will not drain out since the gel is sealed within the rubber bag 21, which is wound around the positioning core 12 several circles. Despite of the pressure applied thereon, the gel 22 cannot drain out. But the deformation of the thin bag 2 is easily maintained for a longer while.

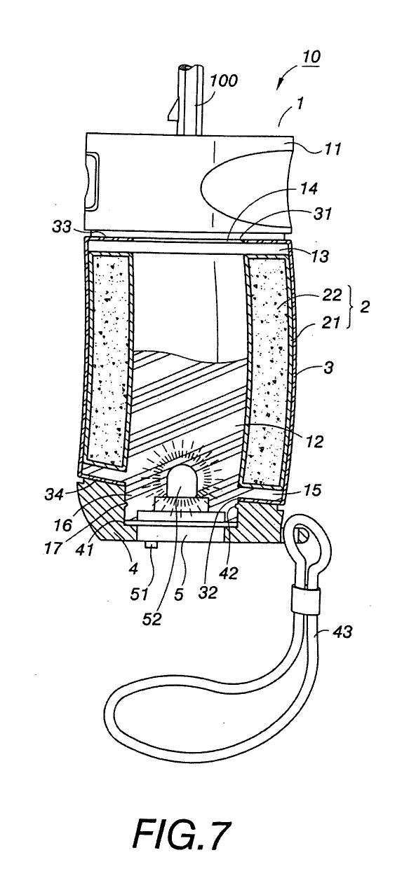

With reference to FIG. 7, a light-emitting device 5 is installed in the base 4. The light-emitting device 5 contains a battery (not shown), a light emitting body 52, a power control switch 51, etc. The light-emitting device 5 is actuated or de-actuated by using a mechanic or a touch switch 51. When the light-emitting device 5 is installed on the base 4; the light emitting body 52 lights upwards so that the lower rod 1, the thin bag 2, and the plastic cover 3 will have apparent alerting effect by the light incident thereupon. Furthermore, to have a preferred effect, the lower rod 1, the thin bag 2 and the plastic cover 3 may be made of transparent or translucent material.

What is claimed is:

1. A pliable handle; the pliable handle being deformable as it being held, when the force is released, the pliable handle will retain a deformed shape temporarily and return to an original shape gradually, the pliable handle comprising:
a middle rod,
a lower rod below the middle rod; the lower rod having a buckling seat and an upper position plate; an upper positioning trench being formed between the buckling seat and the upper positioning plate; and
a thin bag having a plastic cover;
characterized in that: the plastic cover enclosing around the lower rod; the plastic cover containing gel therein, enclosing the lower rod so as to form a space between the lower rod and the thin bag;
the plastic cover enclosing the thin bag; the upper edge of the plastic cover is embedded into the upper positioning trench; and
a base combined with the lower rod and tightly engaging lower edge of the plastic cover.

2. The pliable handle as claimed in claim 1, wherein a light emitting device is installed within the base; the light emitting device includes a light emitting body, at least one battery, and a power control switch; the light of the light emitting body emits toward an upper side.
